(19) United States
(12) Patent Application Publication
(10) Pub. No.: US 2024/0321251 A1
(43) Pub. Date: Sep. 26, 2024

(54) GUITAR CONTROL METHOD, GUITAR AND STORAGE MEDIUM

(71) Applicant: Shenzhen Sound Interactive LTD., Shenzhen (CN)

(72) Inventors: Xu ZHANG, Shenzhen (CN); Jian XIAO, Shenzhen (CN)

(21) Appl. No.: 18/408,012

(22) Filed: Jan. 9, 2024

(30) Foreign Application Priority Data
Mar. 20, 2023 (CN) 2023103022656

(51) Int. Cl. G10H 3/18

(52) U.S. Cl. CPC G10H 3/186; G10H 2210/571

(57) ABSTRACT

A guitar control method, a guitar and a storage medium belongs to the technical field of electronic musical instruments, wherein the guitar includes a fretboard module and strings, the fretboard module comprises a plurality of frets, different frets correspond to different target pitches, and the guitar control method comprises the following steps: obtaining a pressed detection signal of the fretboard module when detecting a first trigger signal of the strings; determining a pressed target fret among the plurality of frets according to the pressed detection signal; determining a first target chord according to the target pitches corresponding to all the target frets; and playing the first target chord.

### TECHNICAL FIELD

The present invention relates to the field of electronic musical instruments, and in particular to a guitar control method, a guitar and a storage medium.

### BACKGROUND ART

The guitar is an instrument with a long history. With the widespread popularity of music, more and more people choose the guitar as an entry-level playing instrument. At present, an entry-level guitar is designed to reduce the intensity of pressing the strings to facilitate a beginner's use. Since corresponding frets and different strings shall be pressed to emit target tones when plucking the strings, multiple frets and strings shall be held down with a left hand and various strings shall be plucked with a right hand for multiple times when playing the chord with a certain thythm, so as to emit multiple target tones to form the chords. Since different chords have different finger positions on fretboard and various methods of plucking the strings, greater difficulty is resulted when playing multiple chords, which makes it more difficult to play the guitar.

The above content is only for facilitate the understanding of the technical solutions of the present invention, and does not mean that the above content can be recognized as the prior art.

### SUMMARY OF THE INVENTION

The main purpose of the present invention is to provide a guitar control method, a guitar and a storage medium, which aims to reduce the difficulty of guitar playing. To achieve the above purpose, the present invention provides a guitar control method which is applied to a guitar, wherein the guitar comprises a fretboard module and strings, the fretboard module comprises frets, different frets correspond to different target tones, and the guitar control method comprises the following steps:
obtaining a pressed detection signal of the fretboard module when detecting a first trigger signal of the strings;
determining a pressed target fret among the frets according to the pressed detection signal;
determining a first target chord according to the target tones corresponding to all the target frets; and
playing the first target chord.

Alternatively, when the first trigger signal of the strings is detected, before obtaining the pressed detection signal of the fretboard module, the method further comprises: obtaining the key of the guitar as the tonic, and determining a preselected tone corresponding to each of the frets according to a major scale;
when the pitch of the preselected tone is within a preset pitch interval, determining the preselected tone as the target tones corresponding to the frets; and
when the pitch of the preselected tone is higher than the preset pitch interval, lowering the pitch of the preselected tone to obtain the target tones corresponding to the frets.

Alternatively, a step of determining the first target chord according to the target tones corresponding to all the target frets comprises:
determining a corresponding chord type according to the number and configuration feature of the target frets;
determining one of all the target tones as a chord root note of the first target chord;
and
determining the first target chord according to the chord type and the chord root note.

Alternatively, a step of playing the first target chord comprises:
determining a play order of the multiple target tones of the first target chord according to a preset rhythm type; and
playing the first target chord according to the play order.

Alternatively, after the step of obtaining the pressed detection signal of the fretboard module when the first trigger signal of the strings is detected, the method further comprises:
ceasing to detect the first trigger signal of the strings and starting timing to obtain timing duration; and
after the step of playing the first target chord, the method further comprising:
when the timing duration is greater than or equal to the first preset duration, starting detecting the first trigger signal, and returning to execute the step of obtaining the pressed detection signal of the fretboard module when the first trigger signal of the strings is detected.

Alternatively, a step of playing the first target chord comprises:
determining an accompaniment style according to the preset rhythm type; determining the number of playing steps of notes included in the first target chord, each of the notes corresponding to each of the steps, and a playing time of each of the steps according to the accompaniment style; and
playing the first target chord according to the number of the playing steps, each of the notes corresponding to each of the steps and the playing time.

Alternatively, the step of playing the first target chord comprises:
obtaining a detection time difference between the first trigger signal and a second trigger signal, the second trigger signal being a trigger signal of the last string detected before the first trigger signal;
determining a target playing method of the first target chord according to the detection time difference; and
playing the first target chord according to the target playing method.

Alternatively, a step of determining the target playing method of the first target chord according to the detection time difference comprises:
determining a broken chord as the target playing method when the detection time difference is greater than a second preset duration;
determining arpeggio as the target playing method when the detection time difference is less than or equal to the second preset duration and the detection time difference is greater than a third preset duration;
determining strumming as the target playing method when the detection time difference is less than or equal to the third preset duration; and
wherein, the second preset duration is greater than the third preset duration.

Besides, in order to achieve the above purpose, the present invention further provides a guitar, which comprises a fretboard module, strings and a guitar control device, wherein the strings and the fretboard module are connected with the guitar control device, the fretboard module comprises a plurality of frets, and different frets correspond to different target tones; and
the guitar control device comprises: a memory, a processor, and a guitar control program stored on the memory and executable on the processor, and the guitar control program is configured for realizing the steps of any one of the guitar control method described above.

Besides, in order to achieve the above purpose, the present invention further provides a storage medium, wherein a guitar control program is stored on the storage medium, and when the guitar control program is executed by a processor, the steps of any one of the guitar control method described above is realized.

The present invention provides the guitar control method which is applied to the guitar, wherein the guitar comprises the fretboard module and the strings, the fretboard module comprises a plurality of frets, different frets correspond to the different target tones, the present method obtains the pressed detection signal of the fretboard module when detecting the first trigger signal of the strings; the present method determines the pressed target fret among the plurality of frets according to the pressed detection signal; and the present method determines the first target chord according to the target tones corresponding to all the target frets. Compared with the existing entry-level guitar wherein only one or more notes can be emitted at the same time at one time, when the strings are plucked at one time, the present invention can detect the first trigger signal and obtain the pressed detection signal, so that the target chord tone consisting of multiple tones can be emitted for several times at different times step by step according to the accompaniment style; and for the current entry-level guitar, it is necessary to pluck multiple strings and press the corresponding different strings and different frets with a left hand to emit multiple tones to form the chord, and the present application simplifies the method of pressing the strings and plucking the strings to emit multiple tones, so that the present application only requires to press one or two frets to emit the chord, and there is no need to consider the different strings and that the number of plucked strings is less than that of plucked strings required by the current entry-level guitar, which reduces the difficulty of cooperation between the strings and the frets during chord performance, and further reduces the difficulty of guitar playing.

### BRIEF DESCRIPTION OF DRAWINGS

FIG. 1 is a structural diagram of one embodiment of a guitar of the present invention;

FIG. 2 is a structural diagram of a hardware operating environment involved in a guitar solution in the embodiment of the present invention;

FIG. 3 is a flow diagram of a first embodiment of a guitar control method of the present invention;

FIG. 4 is a flow diagram of a second embodiment of the guitar control method of the present invention;

FIG. 5 is a flow diagram of a third embodiment of the guitar control method of the present invention;

The realization of the purpose, functional features and advantages of the present invention will be further illustrated with reference to the embodiments and the accompanying drawings.

### SPECIFIC EMBODIMENTS

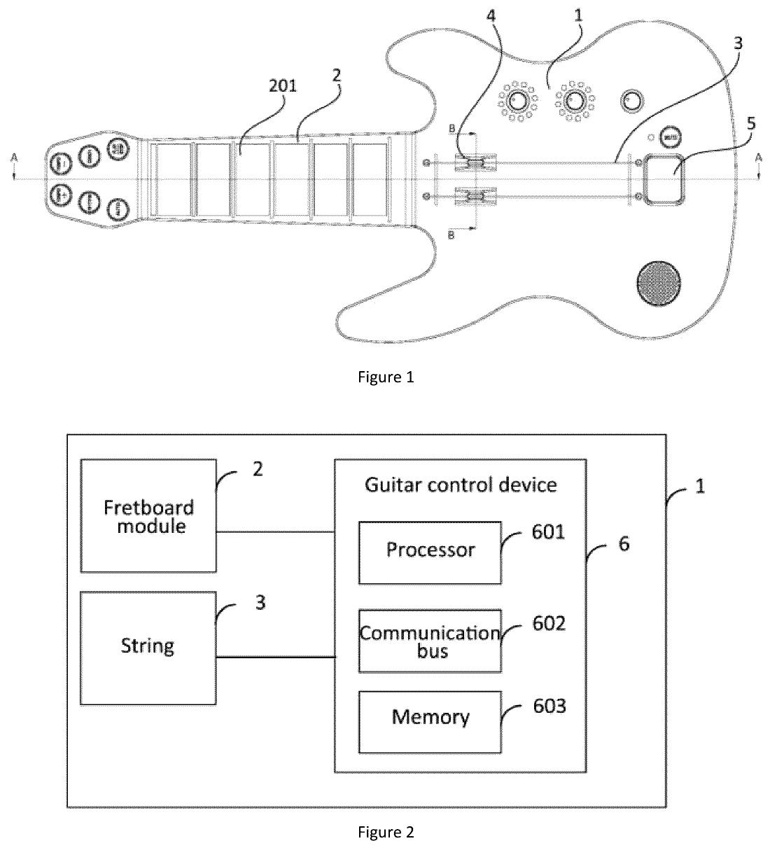

It should be understood that the specific embodiments described herein are only for explaining the present invention and are not intended to limit the present invention. Referring to FIG. 1, which is a structural diagram of one embodiment of a guitar of the present invention. The guitar 1 comprises a fretboard module 2, strings 3, trigger detection devices 4 and a muffling device 5, wherein the fretboard module 2 comprises a plurality of frets 201, different frets 201 correspond to different target tones. The trigger detection devices 4 are made of piezoelectric ceramics, which may alternatively be a buzzer or a piezoelectric cable. The piezoelectric material can convert a vibration signal of the strings 2 into an AC electrical signal, and the generated electrical signal is converted into a DC signal with a regular waveform similar to a right triangle through a charging and discharging circuit, which facilitates detection for the processor 601. In addition, the guitar further comprises a drum machine for providing percussion accompaniment and six LEDs for indicating the rhythm.

For those skilled in the art, it should be understood that the structure shown in FIG. 2 does not constitute a limitation to the guitar 1, and it may comprise more or less parts than shown, or it may be combined with certain parts or arranged with different parts.

Referring to FIG. 2, which is a structural diagram of a hardware operating environment involved in a guitar solution in the embodiment of the present invention. As shown in FIG. 2, the guitar 1 may comprises a guitar control device 6, a fretboard module 2 and strings 3, trigger detection devices 4 and a muffling device 5, wherein the strings 3 and the fretboard module 2 are connected with the guitar control device 6.

The guitar 1 may comprises a processor 601, such as a Central Processing Unit (CPU), a chip capable of Digital Signal Processing (DSP), a communication bus 602 and a memory 603. Wherein, the communication bus 602 is used to realize connection communication between the parts. The memory 603 may be a high-speed Random Access Memory (RAM) memory or a stable Non-Volatile Memory (NVM), such as a disk memory. The memory 603 may alternatively be a storage device independent of the aforementioned processor 601.

As shown in FIG. 2, the memory 603 as a storage medium may comprise an operating system, a data storage module, a sound synthesis module, a signal processing module and a guitar control program.

In the guitar control device shown in FIG. 2, the processor 601 and the memory 602 in the guitar control device of the present invention can be arranged in the guitar control device, wherein the guitar control device invokes the guitar control program stored in the memory 603 through the processor 601 and executes the guitar control method provided by the embodiment of the present invention.

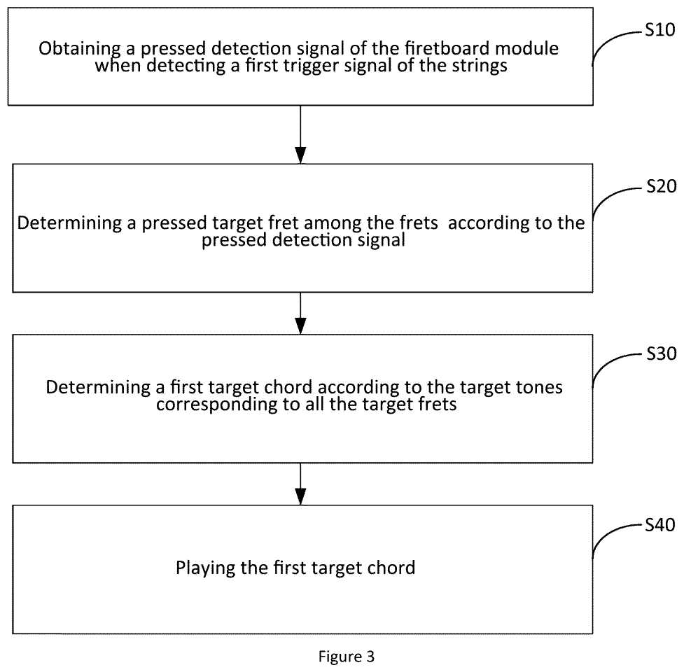

An embodiment of the present invention provides a guitar control method, referring to FIG. 3, which is a flow diagram of the first embodiment of a guitar control method of the present invention.

In the present embodiment, the guitar control method comprises:
Step S10. Obtaining a pressed detection signal of the fretboard module when detecting a first trigger signal of the strings; and
herein, the first trigger signal refers to the trigger signal generated by plucking the strings, and the frets can be pressing trigger elements such as buttons, keys, etc. The press detection signal herein refers to the signal generated by pressing the frets of the fretboard module.
Step S20. Determining a pressed target fret among the plurality of frets according to the pressed detection signal; and
since pressing different frets generates different signals, the pressed target fret among the plurality of frets can be determined according to the pressed detection signal.
Step S30. Determining a first target chord according to the target tones corresponding to all the target frets; and
since different target frets correspond to different target tones, the first target chord can be determined according to the target tones.
Step S40. Playing the first target chord.

Herein, the strings are not used to emit sounds, but to play the first target chord through the sound device.

In the present embodiment, compared with existing entry-level guitars that require pressing multiple strings and fret positions and plucking multiple strings to emit chord accompaniment style, the present application is equivalent to determining the paying time of the chord when detecting the first trigger signal, and by the pressed detection signal, the played chord is determined directly instead of a single note, which simplifies the steps of determining the chord by the frets, and further reduces the difficulty of playing the chord by reducing the difficulty of guitar playing.

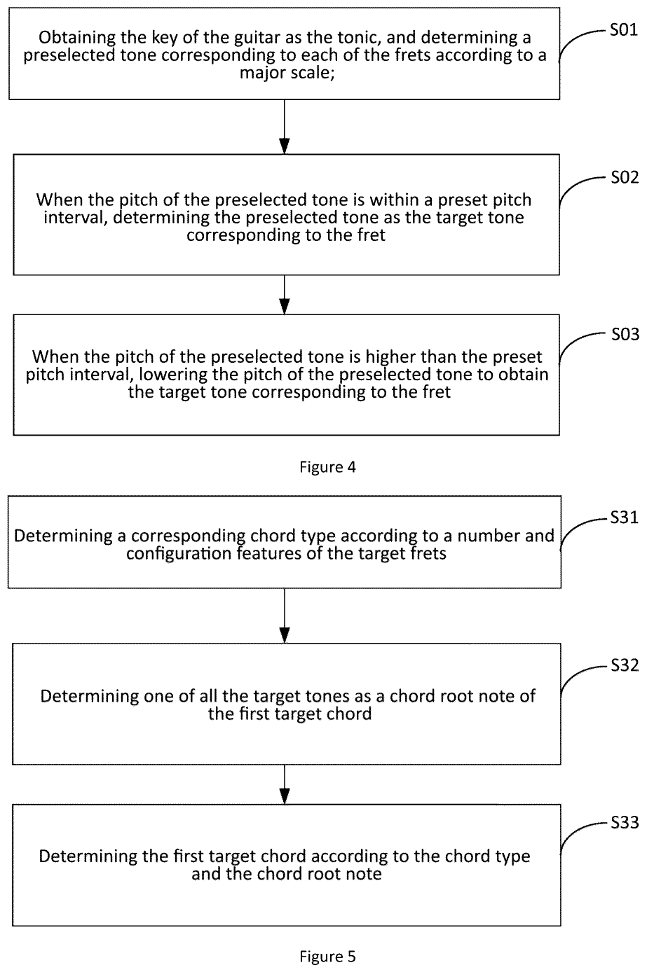

Further, based on the first embodiment, the second embodiment of the guitar control method of the present invention is proposed. Referring to FIG. 4, when the first trigger signal of the strings is detected, before the step of obtaining the pressed detection signal of the fretboard module, the method further comprises:
Step S01. Obtaining the key of the guitar, taking the key as the tonic, and determining a preselected tone corresponding to each of the frets according to a major scale; and herein, the key can be C, C#, D, D #, etc., wherein the tonic is a core of a mode. Specifically, when the tonic is C, the preselected tones on the fretboard are C, D, E, F, G, A, and B according to the major scale. When the tonic is D, the preselected tones are determined to comprise D, E, #F, G, A, B, and #C according to the D major scale. In the embodiment, the number of the frets can be 7, and each of the frets corresponds to one pre-selected tone. In other embodiments, the number of the frets can be six, corresponding to a preselected tone when not any fret is pressed. In other embodiments, the preselected tones may be determined according to the diatonic scale, and the arrangement order can be different.
Step S02. When the pitch of the preselected tone is within a preset pitch interval, determining the preselected tone as at least one target tone corresponding to at least one fret; and
in the present embodiment, the preset pitch interval comprises 12 tones, 60 is the pitch of middle C, and the preset pitch interval is 40-51. When the pitch of the preselected tone is within a preset pitch interval, the preselected tone is determined as the target tone corresponding to the fret.
Step S03. When the pitch of the preselected tone is higher than the preset pitch interval, lowering the pitch of the preselected tone to obtain the target tones corresponding to the frets.

Herein, the pitch of the preset tone is lowered by one octave as the pitch reduction step, so that the preselected tone is within the preset pitch interval, and the target tone corresponding to the fret is obtained.

In the present embodiment, compared with the special phonemes of the guitar strings, the preselected tone is determined through the diatonic scale, which is easier for beginners to understand, remember and master, and further reduces the difficulty of guitar playing.

Further, based on any one of the above embodiments, the third embodiment of the guitar control method of the present invention is proposed. In the embodiment, referring to FIG. 5, a step of determining the first target chord according to the target tones corresponding to all the target frets comprises:
Step S31. Determining a corresponding chord type according to the number and configuration feature of the target frets; and

Herein, the chord types comprise Major Third Chord (MAJOR), Minor Third Chord (MINOR), Dominant Seventh (DOMINANT7), Half-diminished Seventh (MINOR7B5), etc. Specifically, by establishing a corresponding table, the chord types can be determined by the table the number and configuration feature of the target frets. The corresponding table is as follows:

| | | With two fingers (current fret and a fret |
|---|---|---|
| | | whose number is the number of the |
| Fret | With single finger | current fret plus 1) |
| 1 | MAJOR | DOMINANT 7 |
| 2 | MINOR | MAJOR |
| 3 | MINOR | MAJOR |
| 4 | MAJOR | MINOR |
| 5 | MAJOR | DOMINANT 7 |
| 6 | MINOR | MAJOR |
| 7 | MINOR 7B5 | / |

In other embodiments, the chord types such as Major Seventh (MAJOR 7) and Minor Seventh (MINOR 7), etc. may further be comprised, and the number of target frets may be three or more. The configuration feature may also be multiple target cells that are spaced apart or adjacent to each other.
Step S32. Determining one of all the target tones as a chord root note of the first target chord; and

When the number of the target frets is 1, the chord root note is the target tone corresponding to the target fret, and when the number of the target frets is greater than 1, the chord root note can be determined according to a preset rule. Specifically, when two adjacent frets are pressed, the chord root note is determined as the target tone corresponding to a front fret.
Step S33. Determining the first target chord according to the chord type and the chord root note.

The target tone of the first target chord is determined according to the root note of the chord and the chord type. Specifically, the target tone of the first target chord can be determined by checking the table. Specifically, when the chord type is MAJOR, the table for determining the target tone according to the root note is as follows (the pitch in the table is shown by middle C of 60):

| | | Pitch of the first | Pitch of the second | Pitch of the third |
|---|---|---|---|---|
| | | target tone, | target tone, | target tone, |
| | | corresponding to | corresponding to | corresponding to the |
| | Pitch of the | the first string of | the 2^{nd} string of the | third string of the |
| Root note | root note | the acoustic guitar | acoustic guitar | acoustic guitar |
| E | 40 | 64 | 59 | 56 |
| F# | 41 | 65 | 60 | 57 |
| F | 42 | 66 | 61 | 58 |
| G | 43 | 67 | 59 | 55 |
| G# | 44 | 68 | 63 | 60 |
| A | 45 | 64 | 61 | 57 |
| A# | 46 | 65 | 62 | 58 |
| B | 47 | 66 | 63 | 59 |
| C | 48 | 64 | 60 | 55 |
| C# | 49 | 65 | 61 | 56 |
| D | 50 | 66 | 62 | 57 |
| D# | 51 | 67 | 63 | 58 |

For an acoustic guitar, the root note of the chord is usually played on the 4th to 6th strings of the guitar, and other target tones are usually played on the 1st to 3rd strings, so only the pitch of the root note and the pitches of the 1st, 2nd, and 3rd strings are listed above. Therefore, the target chord can be determined based on the chord type and root note. In other embodiments, an association list of frets and target chords may be established, from which the target chord is determined. Specifically, in the free playing mode, different pressing methods can be set to correspond to different chords according to the different styles required. For example, when the tonic is C, D chord, Fm chord and A chord are added to the pop/folk style, the pressing methods thereof are respectively simultaneously holding down the second fret and the third fret, simultaneously holding down the fourth fret and the fifth fret, and simultaneously holding down the sixth fret and the seventh fret. When D7 chord, Fm7 chord and A7 chord are added to the Latin style, the pressing methods thereof are respectively simultaneously holding down the second fret and the third fret, simultaneously holding down the fourth fret and the fifth fret, and simultaneously holding down the sixth fret and seventh fret.

In the present embodiment, the first target chord is determined by the chord type and the chord root note, so that any chord that needs to be used during playing can be determined by the number and configuration feature of the pressed target frets, and the chord can be played without need for complicated left-handed fingering, which reduces the difficulty of playing the chord, and further reduces the difficulty of guitar playing.

Further, based on any one of the above embodiments, the fourth embodiment of the guitar control method of the present invention is proposed. In the embodiment, a step of playing the first target chord comprises:
determining a play order of the multiple target tones of the first target chord according to a preset rhythm type; and
playing the first target chord according to the play order.

In guitar playing, there is a playing method of broken chord, wherein multiple target tones in the first target chord can be played in different orders. In other embodiments, the play order of the first target chord including the target tone can be determined according to the order of the first trigger signal and the second trigger signal when to be played.

In the present embodiment, the play order is determined by the preset rhythm type, which increases the playing method and further improves the flexibility of guitar playing.

Further, based on any one of the above embodiments, the fifth embodiment of the guitar control method of the present invention is proposed. In the embodiment, after the step of obtaining the pressed detection signal of the fretboard module when the first trigger signal of the strings is detected, the method further comprises:
ceasing to detect the first trigger signal of the strings and starting timing to obtain timing duration; and
after the step of playing the first target chord tone, the method further comprising: when the timing duration is greater than or equal to the first preset duration, starting detecting the first trigger signal, and returning to execute the step of obtaining the pressed detection signal of the fretboard module when the first trigger signal of the strings is detected.

In the present embodiment, the strings herein refer to all the strings on the guitar. Since the playing speed of a person is limited, the first preset duration can be determined by determining the fastest playing speed of an average person during playing. In other embodiments, within the first preset duration after triggering, a voltage greater than the voltage threshold needs to be collected before the trigger is determined. The voltage threshold herein may be determined according to the maximum voltage of the previous trigger signal.

In the embodiment, a problem of secondary triggering caused by unsatisfactory first trigger signal or mistriggering can be solved by setting the first preset duration, to improve the stability of guitar playing.

Further, based on any one of the above embodiments, the sixth embodiment of the guitar control method of the present invention is proposed. In the embodiment, a step of playing the first target chord comprises:
determining an accompaniment style according to the preset rhythm type;
determining the number of playing steps of notes included in the first target chord, each of the notes corresponding to each of the steps, and a playing time of each of the steps according to the accompaniment style; and
playing the first target chord according to the number of the playing steps, each of the notes corresponding to each of the steps and the playing time.

In the present embodiment a fully automatic mode is adopted, the accompaniment style of each rhythm is determined according to the preset rhythm type, and the accompaniment style determines the number of playing steps of the first target chord in a complete rhythm, each of the notes corresponding to each of the steps and the playing time corresponding to each of the steps. According to the number of the playing steps and each of the notes corresponding to each of the steps, the notes corresponding to the first target chord are played according to the playing time. Wherein, the number of the playing steps, the notes corresponding to each of the steps and the playing time are determined by the accompaniment style.

In the present embodiment, the playing of the first target chord is controlled according to the accompaniment style, and the complete rhythm of the first target chord can be played when the string is plucked once, which reduces the difficulty of guitar playing.

Further, based on any one of the first to fifth embodiments, the seventh embodiment of the guitar control method of the present invention is proposed. In this embodiment, the step of playing the first target chord comprises:
obtaining a detection time difference between the first trigger signal and a second trigger signal, the second trigger signal being a trigger signal of the last at least one string detected before the first trigger signal;
determining a target playing method of the first target chord according to the detection time difference; and
playing the first target chord according to the target playing method.

In the present embodiment, the second trigger signal may be on different strings from the first trigger signal, and different target playing methods can be determined according to the detection time difference, and the target playing method will affect the playing effect of the first target chord. Specifically, when the number of the strings is two or more, each of the strings is in the detection of the first trigger signal, and when the player quickly plucks two or more strings, the detection time difference between the first trigger signal and the second trigger signal is obtained, so as to determine the target playing method of the first target chord. It should be noted that in the embodiment, the step of ceasing to detect the first trigger signal of the strings and starting timing to obtain timing duration, when the timing duration is greater than or equal to the first preset duration, starting detecting the first trigger signal aims at the first trigger signal of the same string, namely, when the first trigger signal and the second trigger signal are in different strings, the detection time difference may be less than the first preset duration. In other embodiments, different target playing methods may be determined according to the strength of plucking the strings.

In the present embodiment, the target playing method is determined by the detection time difference, so that the playing effect of the first target chord is affected by the speed of plucking the strings during playing, which improves the flexibility of the guitar function.

Further, a step of determining the target playing method of the first target chord according to the detection time difference comprises:
determining broken chord as the target playing method when the detection time difference is greater than the second preset duration;
determining arpeggio as the target playing method when the detection time difference is less than or equal to the second preset duration and the detection time difference is greater than the third preset duration;
determining strumming as the target playing method when the detection time difference is less than or equal to the third preset duration; and
wherein, the second preset duration is greater than the third preset duration.

In the present embodiment, when the number of the strings is 1, the third preset duration herein is greater than the first preset duration. Broken chord refers to playing the notes of the chord according to a certain rhythm and order, playing of the broken chord is usually divided into root notes and other notes, wherein the other notes are the target tones. Arpeggios are generally the notes of each of the strings played from the bass strings to the treble strings in sequence. The speed of a faster song is 120 BPM, so the time of one beat is 500 ms, and the time of ¼ beat is 125 ms. Because the broken chord is rarely played to a note in ¼ beat, a certain margin can be considered according to the time, and 100 ms is considered as the second preset duration. When the detection time difference is equal to or less than 100 ms and is greater than the third preset duration, the arpeggio effect is played, so that the arpeggio effect can be achieved with two strings. When the playing method is strumming, the preset rhythm type corresponding to the chord to be played by strumming is modified to the rhythm type of strumming, and the sample of the strumming is played. In other embodiments, a sound control button may be provided for controlling stopping playing, controlling the playing of muted sounds, controlling the playing of harmonics, etc. Specifically, pressing the sound control button turns off all the tones being played. When the sound control button is pressed for the fourth preset duration, a muted tone is played when there is a trigger signal. When the sound control button is in a pressed state before the first trigger signal is detected, and after the first trigger signal is detected, the sound control button changes from a pressed state to an unpressed state, and the corresponding harmonic of the first target chord tone is played.

In the present embodiment, by comparing the detection time difference with the second preset duration and the third preset duration, different playing methods are determined to be used, which improves the flexibility of playing the chord on the guitar.

In addition, one embodiment of the present invention further provides a storage medium, wherein a guitar control program is stored on the storage medium, and when the guitar control program is executed by a processor, the step of any one of the guitar control method described above is realized.

It should be noted that, the terms “comprising”, “including” or any other variation thereof used herein are intended to cover a non-exclusive inclusion, so that a process, method, article or system that comprise a series of elements not only comprise those elements, but also may comprise other elements not explicitly listed or further comprise the elements inherent to such process, method, article or system. Without further limitation, an element defined by the statement “comprises a . . . ” does not exclude that there are additional identical elements in the process, method, article, or system.

The above serial numbers of the embodiments of the present invention are only for description and do not represent the advantages and disadvantages of the embodiments.

Through above description of the embodiments, those skilled in the art can clearly understand that the methods of the above embodiments can be achieved by means of software and the necessary general hardware platform, and it can also be implemented by hardware, but in many cases the former is a better embodiment. Based on the understanding, technical solutions of the present invention can be embodied in the form of a software product in nature or in part that contributes to the existing technology. The computer software product is stored in a storage medium as mentioned above (such as ROM/RAM, a magnetic disk, an optical disk), comprising several instructions to cause a terminal device (which can be a mobile phone, a computer, a server, or a network device, etc.) to execute the methods described in various embodiments of the present invention.

The above are only preferred embodiments of the present invention, and do not limit the patent scope of the present invention. Any equivalent structure or equivalent process transformation made by using the description and drawings of the present invention may be directly or indirectly used in other related technical fields, which equally fall within the patent protection scope of the present invention.

1. A guitar control method, for application on a guitar, wherein the guitar comprises a fretboard module and strings, the fretboard module comprises frets, different frets correspond to different target tones, and the guitar control method comprises the following steps:
obtaining a pressed detection signal of the fretboard module when detecting a first trigger signal of the strings;
determining a pressed target fret among the frets according to the pressed detection signal;
determining a first target chord according to the target tones corresponding to all the target frets; and
playing the first target chord.

2. The guitar control method according to claim 1, wherein when the first trigger signal of the strings is detected, before obtaining the pressed detection signal of the fretboard module, the method further comprises:
obtaining the key of the guitar as the tonic, and determining a preselected tone corresponding to each of the frets according to a major scale;
when the pitch of the preselected tone is within a preset pitch interval, determining the preselected tone as the target tone corresponding to the fret; and
when the pitch of the preselected tone is higher than the preset pitch interval, lowering the pitch of the preselected tone to obtain the target tone corresponding to the fret.

3. The guitar control method according to claim 1, wherein a step of determining the first target chord according to the target tones corresponding to all the target frets comprises:
determining a corresponding chord type according to a number and configuration features of the target frets;
determining one of all the target tones as a chord root note of the first target chord; and
determining the first target chord according to a chord type and the chord root note.

4. The guitar control method according to claim 1, wherein a step of playing the first target chord comprises:
determining a play order of the multiple target tones of the first target chord according to a preset rhythm type; and
playing the first target chord according to the play order.

5. The guitar control method according to claim 1, wherein after obtaining the pressed detection signal of the fretboard module when the first trigger signal of the strings is detected, the method further comprises:
ceasing to detect the first trigger signal of the strings and starting timing to obtain timing duration; and
after playing the first target chord, the method further comprising:
when the timing duration is greater than or equal to the first preset duration, starting detecting the first trigger signal, and returning to execute the step of obtaining the pressed detection signal of the fretboard module when the first trigger signal of the strings is detected.

6. The guitar control method according to claim 1, wherein a step of playing the first target chord comprises:
determining an accompaniment style according to the preset rhythm type;
determining a number of playing steps of notes included in the first target chord, each of the notes corresponding to each of the steps, and a playing time of each of the steps according to the accompaniment style; and
playing the first target chord according to the number of the playing steps, each of the notes corresponding to each of the steps and the playing time.

7. The guitar control method according to claim 1, wherein the step of playing the first target chord comprises:
obtaining a detection time difference between the first trigger signal and a second trigger signal, the second trigger signal being a trigger signal of the last string detected before the first trigger signal;
determining a target playing method of the first target chord according to the detection time difference; and
playing the first target chord according to the target playing method.

8. The guitar control method according to claim 7, wherein a step of determining the target playing method of the first target chord according to the detection time difference comprises:
determining broken chord as the target playing method when the detection time difference is greater than the second preset duration;
determining arpeggio as the target playing method when the detection time difference is less than or equal to the second preset duration and the detection time difference is greater than the third preset duration;
determining strumming as the target playing method when the detection time difference is less than or equal to the third preset duration; and
wherein, the second preset duration is greater than the third preset duration.

9. A guitar comprises a fretboard module, strings and a guitar control device, wherein the strings and the fretboard module are connected with the guitar control device, the fretboard module comprises a plurality of frets, and different frets correspond to different target tones; and
the guitar control device comprises: a memorizer, a processor, and a guitar control program stored on the memorizer and executable on the processor, and the guitar control program is configured for realizing the step of the guitar control method according to claim 1.

10. A storage medium, wherein a guitar control program is stored on the storage medium, and when the guitar control program is executed by a processor, the step of the guitar control method according to claim 1 is realized.

11. The guitar control method according to claim 4, wherein the step of playing the first target chord comprises:
obtaining a detection time difference between the first trigger signal and a second trigger signal, the second trigger signal being a trigger signal of the last string detected before the first trigger signal;
determining a target playing method of the first target chord according to the detection time difference; and
playing the first target chord according to the target playing method.

12. The guitar control method according to claim 5, wherein the step of playing the first target chord comprises:
obtaining a detection time difference between the first trigger signal and a second trigger signal, the second trigger signal being a trigger signal of the last string detected before the first trigger signal;
determining a target playing method of the first target chord according to the detection time difference; and
playing the first target chord according to the target playing method.

13. The guitar control method according to claim 6, wherein the step of playing the first target chord comprises:
obtaining a detection time difference between the first trigger signal and a second trigger signal, the second trigger signal being a trigger signal of the last string detected before the first trigger signal;
determining a target playing method of the first target chord according to the detection time difference; and
playing the first target chord according to the target playing method.

14. The guitar control method according to claim 11, wherein a step of determining the target playing method of the first target chord according to the detection time difference comprises:
determining broken chord as the target playing method when the detection time difference is greater than the second preset duration;
determining arpeggio as the target playing method when the detection time difference is less than or equal to the second preset duration and the detection time difference is greater than the third preset duration;
determining strumming as the target playing method when the detection time difference is less than or equal to the third preset duration; and
wherein, the second preset duration is greater than the third preset duration.

15. The guitar control method according to claim 12, wherein a step of determining the target playing method of the first target chord according to the detection time difference comprises:
determining broken chord as the target playing method when the detection time difference is greater than the second preset duration;
determining arpeggio as the target playing method when the detection time difference is less than or equal to the second preset duration and the detection time difference is greater than the third preset duration;
determining strumming as the target playing method when the detection time difference is less than or equal to the third preset duration; and
wherein, the second preset duration is greater than the third preset duration.

16. The guitar control method according to claim 13, wherein a step of determining the target playing method of the first target chord according to the detection time difference comprises:
determining broken chord as the target playing method when the detection time difference is greater than the second preset duration;
determining arpeggio as the target playing method when the detection time difference is less than or equal to the second preset duration and the detection time difference is greater than the third preset duration;
determining strumming as the target playing method when the detection time difference is less than or equal to the third preset duration; and
wherein, the second preset duration is greater than the third preset duration.
